(19) United States
(12) Patent Application Publication
(10) Pub. No.: US 2011/0110618 A1
(43) Pub. Date: May 12, 2011

(54) BEARING RING

(75) Inventor: Christian Proeschel, Wuerzburg (DE)

(73) Assignee: SCHAEFFLER TECHNOLOGIES GMBH & CO. KG, Herzogenaurach (DE)

(21) Appl. No.: 12/674,091

(22) PCT Filed: Aug. 27, 2008
(86) PCT No.: PCT/DE08/01429

§ 371 Date: Feb. 18, 2010

(30) Foreign Application Priority Data
Sep. 6, 2007 (DE) 10 2007 042 372.3

(51) Int. Cl. F16C 43/04

(52) U.S. Cl. 384/585

(57) ABSTRACT

A bearing ring which is has a reliable and maintenance-free protection from frictional corrosion on the fits of the bearing ring. The protection is already effective during assembly. The bearing ring has a wall that has a frictional corrosion-resistant layer in at least those regions that are in contact with a machine component via a fit when assembled.

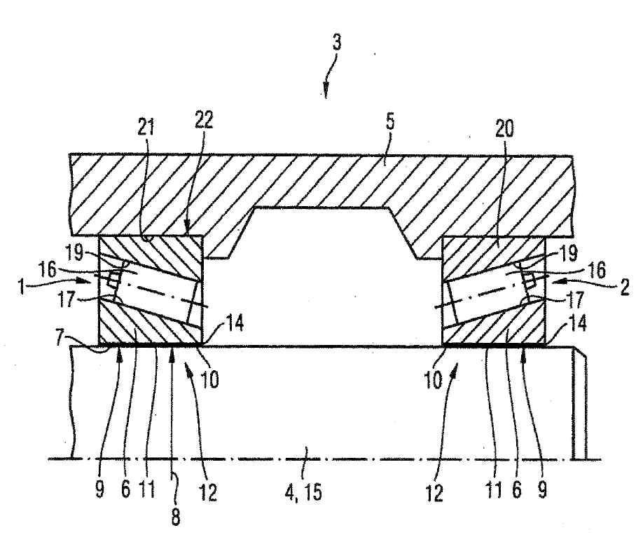

### FIELD OF THE INVENTION

The invention relates to the field of rolling bearings and plain bearings, in which an outer bearing ring is rotationally moveable relative to an inner bearing ring. Here, rolling bodies (rolling bearings) or sliding surfaces (plain bearings) may be provided between the bearing rings. Bearings such as these are widely used, where frequently at least one of the bearing rings is connected frictionally to a machine element, or is fixed to it, by means of a fit, e.g. a press fit. This makes it possible for a machine element to be mounted in a rotationally moveable manner.

In the context of the present invention, the term “machine element” is to be understood in broad terms and encompasses, for example, shafts, axles or axle pins.

The use of a fit to fix a bearing ring is common and also preferred for manufacturing technology reasons because it is relatively simple to produce and assemble this connection. However, the quality, in particular the long-term stability and thus the reliability, of a bearing depends quite considerably on the reliable seat of the parts connected by means of a fit. What is undesirable here is a relative movement or what is known as working of the fitted partners relative to each other. In practice, however, this cannot always be ruled out.

Even the smallest relative movements of the fitted partners may result in corrosion phenomena which are also referred to as frictional corrosion or frictional oxidation. Frictional corrosion or frictional oxidation is understood to mean a type of oscillatory wear in the region of the contact surfaces and fit surfaces. Oscillations which occur during operation cause vibrations which unfavorably result in slipping of the connection partners, i.e. a micro relative movement of the bearing ring in relation to the machine element. The mechanical surface loading which occurs in the process results in spoiling and activation of the material surfaces. This leads to chemical reactions with the surrounding medium, in particular to oxidation. The oxidation which occurs as a result of contact with the surrounding medium (air, lubricant, water or the like) mostly results in blackish corrosion, which is consequently referred to as frictional corrosion.

In principle, it is conceivable to counteract this phenomenon by bonding the fit gap together or sealing it with respect to the surroundings. This increases the manufacturing outlay and nevertheless cannot always guarantee reliable protection in all cases of loading and/or in aggressive use environments.

Against this background, the object of the invention is to provide a bearing ring with reliable, maintenance-free protection, already effective during assembly, against frictional corrosion.

According to the invention, this object is achieved by a bearing ring having the features of patent claim 1.

According to this claim, the wall of the bearing ring is provided with a frictional-corrosion-resistant layer at least in those regions which are in contact with a machine element via a fit when assembled. Metallic or metal-containing layers, which can be applied by chemical and/or electrochemical deposition processes, are particularly suitable as this layer. It is also conceivable to apply layers of plastic or carbon to the wall in a permanent bond.

The invention therefore provides, in a surprisingly simple manner, reliable protection against frictional corrosion; this protection is applied in a relatively simple manner as early as during the production of the bearing ring and does not require any additional production steps—such as, for example, the above-described sealing measures—during or after the assembly of the bearing ring on or in the corresponding machine element.

A further advantage of the invention is that the frictional-corrosion-resistant layer is retained even when the bearing ring is removed and possibly reassembled, and can continue to show its protective effect. This has the additional advantage that jamming of the fitted partners by frictional corrosion is reliably prevented during removal.

Particularly reliable protection which is preferred in terms of manufacturing technology can be obtained in that, according to advantageous refinements of the invention, the wall of the bearing ring to be coated is coated with copper, cadmium, silver or chromium.

A further advantageous embodiment of the invention provides for the wall of the bearing ring to be phosphatized.

According to a further advantageous refinement of the invention, the wall of the bearing ring is coated with a plastic, particularly preferably with Teflon®.

An exemplary embodiment of the invention and further advantages of the invention are explained below with reference to the single FIGURE in the drawing.

The FIGURE shows, as an exemplary embodiment, two rolling bearings 1, 2 which are part of a bearing arrangement 3 and are assembled in a so-called O-arrangement. An outer bearing ring housing 5 is rotatably mounted on an axle pin 4 by means of the bearing arrangement. In the course of the description below, reference is made to the rolling bearing 1, the rolling bearing 2 being designed in a corresponding manner.

The rolling bearing 1 comprises an inner bearing ring 6 with a bore 7. The inside diameter 8 of the bore is delimited by a wall 9. A frictional-corrosion-resistant layer 10 is applied to the wall 9. This layer 10 can consist of copper 11, for example. The layer 10 is applied at least in those regions 12 of the wall which, in the assembled state shown, are connected via a fit 14 to a machine element 15—here specifically to the axle pin 4—or are fixed thereon in a rotationally fixed manner.

In a manner known per se and not shown in detail, the rolling bearing 1 comprises a multiplicity of rolling bodies 16 which roll on the running surface 17 of the inner bearing ring 6. On the outside, the rolling bodies 16 run on the running surface 19 of an outer bearing ring 20. The outer bearing ring is accommodated in a bore 21 of the outer bearing ring housing 5.

In principle, it is also possible for the outer bearing ring 20 to be provided with a corresponding frictional-corrosion-resistant layer in the region 22, in which it is connected to the bore 21, in particular if it is feared that the outer bearing ring 20 will move in relation to the outer bearing ring housing 5 in this case too as a result of operational vibrations or oscillations. Therefore, frictional corrosion can also be prevented between the outer bearing ring housing and the outer bearing ring 20.

The refinement of the bearing ring, according to the invention, with a coating in order to afford protection against frictional corrosion, is particularly advantageous when the bearing arrangement 3 is used in wheel bearings of aircraft, since these are exposed to particularly extreme operating situations which promote frictional corrosion. Here, the advantage of weight reduction and cost reduction, as can be achieved by the invention, has a particularly beneficial effect for the production of the bearing arrangement.

The design of the bearing rings according to the invention makes it possible to dispense with the other possible measures for protecting against frictional corrosion mentioned in the introduction, and this has a positive effect in terms of reduced maintenance outlay and therefore reduced logistics costs for the user. Here, there is the additional advantage in terms of removal that jamming of the fitted partners is reliably prevented during removal.
List of Reference Symbols
1 Rolling bearing
2 Rolling bearing
3 Bearing arrangement
4 Axle pin
5 Outer bearing ring housing
6 Inner bearing ring
7 Bore
8 Inside diameter
9 Wall
10 Frictional-corrosion-resistant layer
11 Copper
12 Region
14 Fit
15 Machine element
16 Rolling body
17 Running surface of the inner ring
19 Running surface of the outer bearing ring
20 Outer bearing ring
21 Bore
22 Connecting region

1. A bearing ring, comprising
a wall, which has a frictional-corrosion-resistant layer at least in regions which are in contact with a machine element via a fit when assembled.

2. The bearing ring of claim 1, wherein the wall is coated with copper.

3. The bearing ring of claim 1, wherein the wall is coated with cadmium.

4. The bearing ring of claim 1, wherein the wall is coated with silver.

5. The bearing ring of claim 1, wherein the wall is coated with chromium.

6. The bearing ring of claim 1, wherein the wall is coated with phosphate.

7. The bearing ring of claim 1, wherein the wall is coated with a plastic.

8. The bearing ring of claim 7, wherein the plastic is Teflon.
